(19) United States
(12) Patent Application Publication
(10) Pub. No.: US 2007/0266188 A1
(43) Pub. Date: Nov. 15, 2007

(54) USB keyboard and human input device using the same

(75) Inventor: Chien-Tsung Chen, Sijhih City (TW)

Correspondence Address: BIRCH STEWART KOLASCH & BIRCH, PO BOX 747, FALLS CHURCH, VA, 22040-0747, US

(73) Assignee: Behavior Tech Computer Corp.

(21) Appl. No.: 11/716,593

(22) Filed: Mar. 12, 2007

(30) Foreign Application Priority Data
May 9, 2006 (TW) 95116310

(51) Int. Cl. G06F 13/38; G06F 13/12

(52) U.S. Cl. 710/67

(57) ABSTRACT

A USB keyboard includes a plurality of keys and a USB controller. The USB controller includes at least a firmware, wherein the USB controller is for executing the firmware. The firmware includes at least two endpoint descriptors, wherein each of the endpoint descriptors operate according to a USB-HID communication standard, and report descriptors of the same amount as the endpoint descriptors, wherein each of the report descriptors is respectively corresponding to one of the endpoint descriptors, and the report descriptors all operate according to the USB-HID communication standard. When at least one of the keys is pressed simultaneously, the USB controller stores key codes corresponding to the simultaneously pressed keys in endpoints defined by the endpoint descriptors, and transmits the key codes stored in the endpoints by executing the firmware.

### RELATED APPLICATIONS

The present application is based on, and claims priority from, Taiwan Application Serial Number 95116310, filed May 9, 2006, the disclosure of which is hereby incorporated by reference herein in its entirety.

### BACKGROUND

1. Field of Invention

The present invention relates to a keyboard for operating a computer system. More particularly, the present invention relates to a universal serial bus (USB) keyboard.

2. Description of Related Art

Presently, it is described in the Appendix B.1 of the Device Class Definition for Human Interface Devices Version 1.11 that in the USB keyboard, more than 6 keys, other than the modifier keys, cannot be pressed simultaneously. However, with the population of game software and the required amount of keys of the keyboard utilized in the game increases, the restriction of the amount of the keys that can be pressed simultaneously becomes an obstacle to playing computer games.

Therefore, it is necessary to introduce an improved USB keyboard, which can handle at least 7 keys pressed simultaneously, and enable a computer to receive all key codes corresponding to those keys.

### SUMMARY

In accordance with the present invention, a USB keyboard is provided that includes a plurality of keys and a USB controller. The USB controller includes at least a firmware, wherein the USB controller is for executing the firmware. The firmware includes at least two endpoint descriptors, wherein each of the endpoint descriptors operate according to the USB-HID communication standard; and report descriptors of the same amount as the endpoint descriptors. Each of the report descriptors is corresponding to one of the endpoint descriptors, and the report descriptors all operate according to the USB-HID communication standard. When at least one of the keys is pressed simultaneously, the USB controller stores key code corresponding to the simultaneously pressed keys is stored in endpoints defined by the endpoint descriptors, and transmits the key codes stored in the endpoints by executing the firmware.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram illustrating a firmware structure of the USB keyboard of the present invention; and

FIG. 2 is a flow chart illustrating the procedure of the firmware dealing about the endpoints according to the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

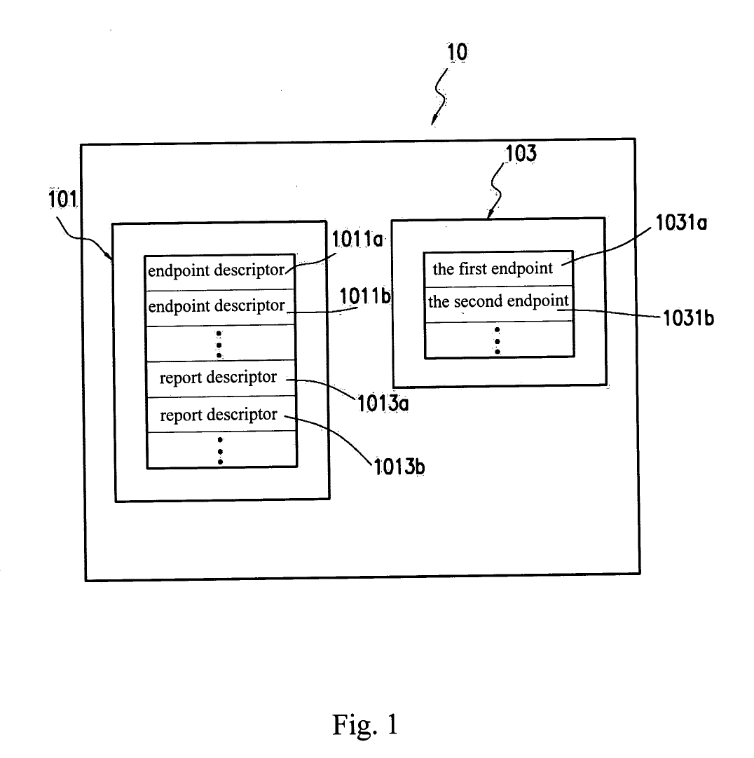

FIG. 1 is a diagram of a firmware structure of the USB keyboard of the present invention. According to the present invention, it is the firmware that is relied on in the present invention to improve the conventional USB keyboard. Therefore, the circuitry of the conventional USB keyboard can be adopted in the present invention directly. Generally, a programmable program embedded in the USB controller 10, for example, an erasable programmable read-only memory (EEPOM), is utilized to store the firmware 101. Please refer to FIG. 1, the firmware 101 includes at least: at least two endpoint descriptors 1011a and 1011b, and report descriptors 1013a and 1013b, wherein the amount of the report descriptors is of the same amount of the endpoint descriptors. For providing a description that is brief and to the point, the other components of the human interface device (HID), such as device descriptors, configuration descriptors, etc., are omitted because they are specified in the USB-HID class document. For one example of the present invention, the components other than the endpoint descriptors 1011a and 1011b and report descriptors 1013a and 1013b can be similar as those specified in the USB-HID class document.

The present invention can be disclosed by embodiments wherein the firmware 101 declares the two endpoint descriptors 1011a and 1011b and the two report descriptors 1013a and 1013b. According to the present invention, one or more keys can be pressed simultaneously. For example, a user may use his or her ten fingers to press 7 or more keys, for example 10 keys, simultaneously, wherein in one example, the ten keys may include the key “0”, the key “1”, the key “2”, the key “3”, the key “4”, the key “5”, the key “6”, the key “7”, the key “8”, and the key “9”. The keys “0” to “9” are then sent to the host server, for example, a computer, via the USB communication link.

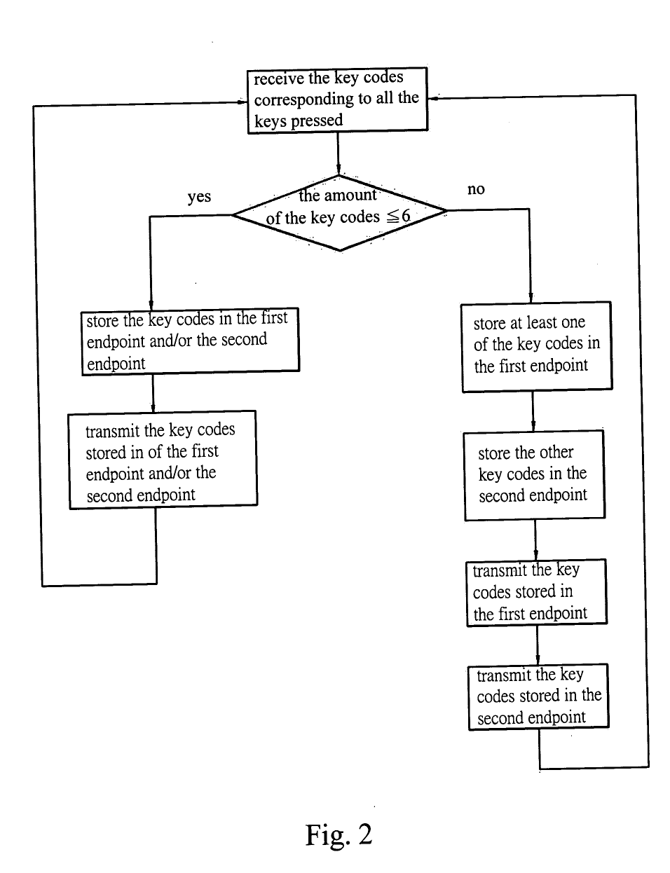

Please refer to FIG. 2. When the USB controller 10 receives ten key codes corresponding to the ten keys “0” to “9” that are mentioned in the example above, the USB controller 10 stores the key code corresponding to at least one of the keys, for example, the first 6 keys (the keys “0” to “5”), in an endpoint 1031a, called the first endpoint in an example, defined by the first endpoint descriptor 1011a by performing the firmware. Next, the USB controller 10 stores the key codes corresponding to the other keys (the key codes corresponding to the keys “6” to “9”) in the example above, to an endpoint 1031b, called the second endpoint in an example, defined by the second endpoint descriptor 1011b by performing the firmware.

Following the example mentioned above, the USB controller 10 respectively transmits the six key codes from the first endpoint 1031a and the four key codes from the second endpoints 1031b. Accordingly, the USB keyboard of the present invention can handle key codes corresponding to ten keys pressed simultaneously. The first six key codes are transmitted by utilization of the first endpoint 1031a, and the last four key codes are transmitted by utilization of the second endpoint 1031b.

When the user presses six or less than six keys simultaneously, the key codes corresponding to the keys that are pressed can be stored by only one or both of the first endpoint 1031a and the second endpoint 1031b. Besides, the USB controller 10 utilizes the only one or both of the first endpoint 1031a and the second endpoint 1031b to transmit the key codes. For example, if the key codes are all stored and sent out in and from the first endpoint 131a, the USB controller 10 does not have to process the second endpoint 1031b since there is no key code stored in the second endpoint 1031b. For further explanation, there can be key codes corresponding to 0, one, or even more than one key that are pressed stored in the first endpoint 1031a, and the key codes corresponding to other keys that are pressed are stored in the second endpoint 1031b. There are key codes stored in at least 0 to 6 endpoints that can be stored in each of the endpoint descriptor.

The first endpoint descriptor 1011a and the second endpoint descriptor 1011b operate according to the USB-HID (human interface device) communication standard. Besides, the first endpoint descriptor 1011a is corresponding to a report descriptor 1013a, and the second endpoint descriptor 1011b is corresponding to another report descriptor 1013b. The two endpoint report descriptors 1013a and 1013b operate according to the USB-HID communication standard as well.

The memory space of the first endpoint 1031a and the second endpoint 1031b mentioned above is a first-in-first-out (FIFO) buffer, which can be a part of the data memory 103 embedded in the USB controller 10. The data memory 103 can include a random access memory (RAM).

It is known that the conventional USB keyboard declares one endpoint descriptor and a report descriptor only. The declaration of the first endpoint descriptor 1011a and the second endpoint descriptor 1011b and the two report descriptors are different from conventional USB keyboard.

The aforementioned example in which the first endpoint 1031a and the second endpoint 1031b of the present invention are allocated to store the key codes corresponding to the keys “0” to “9” may be an exemplary but not restrictive embodiment of the present invention.

Further, it is disclosed in the present invention the variation about how to allocate the key codes to be stored the endpoints. In a first embodiment, when the amount of the keys that are pressed is more than or equal to 7 and is less than 11, the key codes corresponding to at least one key pressed are stored in the first endpoint 1031a, and the key codes corresponding to the other keys pressed are stored in the second endpoint 1031b. In a second embodiment, when the amount of the keys that are pressed is more than or equal to 1 and is less than 7, the key codes corresponding to at least one key pressed are stored in the first endpoint 1031a, and the key codes corresponding to the other keys pressed are stored in the second endpoint 1031b. In a third embodiment, when the amount of the keys that are pressed is less than or equal to 6, the key codes corresponding to all key pressed are stored in the first endpoint 1031a. In a fourth embodiment, when the amount of the keys that are pressed is less than or equal to 6, the key codes corresponding to all key pressed are stored in the second endpoint 1031b.

The USB keyboard consistent with the present invention can be applied as a USB game keyboard for game software. Also, the configuration of the keys of the present USB keyboard can be compatible to the standard key board, such as a 101-key keyboard that is adopted by the PC AT system.

The USB keyboard of the present invention can be installed within other kinds of human input interface (HID) devices, such as a computer mouse, a joystick, or a tablet.

One of the advantages of the present invention is to utilize the USB keyboard that is commonly used nowadays to implement the USB keyboard of the present invention. The cost of the improvement only includes changing the firmware, which is very inexpensive. And another contribution of the present invention is to eliminate the drawback of the prior art, such that the present USB keyboard that can handle 7 or more keys pressed simultaneously.

Although the present invention has been described in considerable detail with reference to certain preferred embodiments thereof, other embodiments are possible. Their spirit and scope of the appended claims should no be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A universal serial bus (USB) keyboard, comprising:
a plurality of keys; and
a USB controller, comprising at least a firmware, wherein the USB controller executes the firmware, the firmware comprising:
at least two endpoint descriptors, wherein the endpoint descriptors all operate according to a USB-HID (human interface device) communication standard; and
report descriptors of the same amount as the endpoint descriptors, wherein each of the report descriptors respectively corresponds one of the endpoint descriptors, and the report descriptors all operate according to the USB-HID communication standard;
wherein when at least one of the keys is pressed simultaneously, the USB controller stores key codes corresponding to the simultaneously pressed keys in endpoints defined by the endpoint descriptors, and transmits the key codes stored in the endpoints by executing the firmware.

2. The USB keyboard of claim 1, wherein the amount of the simultaneously pressed keys is less than or equal to 6, and the key codes corresponding to the simultaneously pressed keys are stored in endpoints defined by one or more than one endpoint descriptor.

3. The USB keyboard of claim 1, wherein the amount of the simultaneously pressed keys is more than or equal to 7, and the key codes corresponding to the simultaneously pressed keys are stored in endpoints defined by one or more than one endpoint descriptor.

4. The USB keyboard of claim 1, wherein the endpoint descriptors comprise a first endpoint descriptor and a second endpoint descriptor.

5. The USB keyboard of claim 4, wherein the amount of the simultaneously pressed keys is more than or equal to 7 and less than 11, the key codes corresponding to at least one simultaneously pressed key are stored in endpoints defined by the first endpoint descriptor, and the key codes corresponding to the other simultaneously pressed keys are stored in endpoints defined by the second endpoint descriptor.

6. The USB keyboard of claim 4, wherein the amount of the simultaneously pressed keys is more than or equal to 1 and less than 7, the key codes corresponding to at least one simultaneously pressed key are stored in endpoints defined by the first endpoint descriptor, and the key codes corresponding to the other simultaneously pressed keys are stored in endpoints defined by the second endpoint descriptor.

7. The USB keyboard of claim 4, wherein the amount of the simultaneously pressed keys is less than or equal to 6, and the key codes corresponding to the simultaneously pressed keys are stored in endpoints defined by the first endpoint descriptor.

8. The USB keyboard of claim 4, wherein the amount of the simultaneously pressed keys is less than or equal to 6, and the key codes corresponding to the simultaneously pressed keys are stored in endpoints defined by the second endpoint descriptor.

9. The USB keyboard of claim 1 being a USB game keyboard for game software.

10. The USB keyboard of claim 1, wherein a configuration of the keys of the USB keyboard is compatible to a standard keyboard.

11. A human input device comprising the USB keyboard of claim 1.
